(19) United States
(12) Patent Application Publication
(10) Pub. No.: US 2019/0019244 A1
(43) Pub. Date: Jan. 17, 2019

(54) SYSTEM AND METHOD TO PROVIDE COMPETITIVE BIDDING TRANSPORTATION SERVICES TO A VARIETY OF CUSTOMERS

(71) Applicant: Fawad Bangash, Palo Alto, CA (US)

(72) Inventor: Fawad Bangash, Palo Alto, CA (US)

(21) Appl. No.: 15/651,170

(22) Filed: Jul. 17, 2017

(51) Int. Cl. G06Q 30/08; G06Q 50/30; G06F 17/30

(52) U.S. Cl. CPC G06Q 30/08; G06F 17/30029; G06Q 50/30

(57) ABSTRACT

Embodiments described herein include a system and method for implementing an electronic competitive bidding system for taxi, charter & delivery services comprise a memory unit configured to store information regarding a plurality of taxi, charter & delivery drivers, and a set of program modules. Information regarding the plurality of taxi, charter & delivery drivers comprises locations of each of the plurality of taxi, charter & delivery drivers and vehicle type and vehicle class of each of the plurality of taxi, charter & delivery drivers. Further, the system comprises a processor to execute the set of program modules. The set of program modules comprises an input module configured to receive user preferences from a user. A bid generation module is configured to receive a set of bids from a set of taxi drivers among the plurality of taxi, charter & delivery drivers. An output module receives from the user a selection for at least one taxi, charter & delivery driver from the set of taxi, charter & delivery drivers.

### FIELD

The embodiments provide relate to electronic competitive bidding and more specifically to a system and method of providing a competitive bidding system to plurality of customers over a wireless network via a mobile application.

### BACKGROUND

The following review and disclosure of the relevant art is intended to show examples of challenges and pitfalls in the prior art. The incorporation of these example does not comprise an admission of identical art. Numerous examples in the prior art disclose the challenges or finding and hailing a taxi cab and precise process and experience for the consumer and service provider (driver). The current systems remain inefficient and have remained unchanged over several decades despite the adoption of internet based auction platform and bidding sites.

Service providers are finding little incentive to subscribe to paid services and the little feedback provided from user has been most negative.

Currently, there are several auction bidding and internet platform that enables a consumer to bid on transportation sites such as U.S. Pat. App. No 2001056396; U.S. Pat. No. 6,756,913; and U.S. Pat. App. No. 2004/0260470. Though each of these references disclose certain aspects and utility associated with providing a competitive bidding platform to a plurality of consumers through a mobile application and over a wireless network, there is no single reference that discloses the specific parameters disclosed in the below-mentioned application.

### SUMMARY OF THE INVENTION

Some of the embodiments shown provides a mobile application which incorporates a pre-programmed software to enable customers to input desired parameters into a mobile application and communicate over a wireless network to a transportation means in response to a competitive bid for a selected location. Through one or more marketplaces established through a subscription basis established on the platform by an administrator, both customer and service provide may interact in a collaborative network to request and receive competitive bids for transportation services.

In one embodiment of the present invention, a system for implementing an electronic competitive bidding system for taxi services comprises a memory unit configured to store information regarding a plurality of taxi, charter & delivery (food or products) drivers, and a set of program modules. Information regarding the plurality of taxi, charter &delivery drivers comprises locations of each of the plurality of taxi, charter & delivery drivers and vehicle type and vehicle class of each of the plurality of taxi drivers. Further, the system comprises a processor to execute the set of program modules. The set of program modules comprising an input module configured to receive user preferences from a user. The user preferences comprise location of the user, travel schedule of the user, car type preferred by the user, transportation type, transportation route, a selected vehicle type and a selected vehicle class and intended destination of the user. A bid generation module is configured to transmit the user preferences to the plurality of taxi, charter & delivery drivers, and receive a set of bids from a set of taxi, charter & delivery among the plurality of taxi, charter & delivery. An output module displays information regarding the set of taxi, charter & delivery drivers and the set of bids, to the user, and receives from the user a selection for at least one (taxi, charter & delivery) driver from the set of (taxi, charter & delivery) drivers.

In another embodiment of the present invention, the input module receives the user preferences from the user via at least one of a personal computer, a tablet computer, and a mobile device. Further, the bid generation module transmits the user preferences to the plurality of taxi, charter & delivery drivers via at least one of a personal computer, a tablet computer, and a mobile device. The memory unit further stores personal profile of the user comprising name of the user, location of the user, and travel history of the user. The bid generation module is further configured to calculate a competitive bid in response to reception of the user preferences from the user. The bid generation module alerts the at least one taxi, charter & delivery driver based on the at least one taxi, charter & delivery driver being selected by the user.

In yet another embodiment of the present invention, a method of implementing an electronic competitive bidding system for taxi, charter & delivery services comprises storing in a memory unit, information regarding a plurality of taxi, charter & delivery drivers, and a set of program modules. Information regarding the plurality of taxi, charter & delivery drivers comprises locations of each of the plurality of taxi, charter & delivery drivers and vehicle type and vehicle class of each of the plurality of taxi, charter & delivery drivers. Further, the method comprises receiving by a processor, via an input module, user preferences from a user. The user preferences comprise location of the user, travel schedule of the user, car type preferred by the user, transportation type, transportation route, a selected vehicle type and a selected vehicle class and intended destination of the user. Further the method comprises transmitting by the processor via a bid generation module, the user preferences to the plurality of taxi, charter & delivery drivers. Furthermore, the method comprises receiving by the processor via the bid generation module a set of bids from a set of taxi drivers among the plurality of taxi, charter & delivery drivers. Moreover, the method comprises displaying by the processor via an output module, information regarding the set of taxi, charter & delivery drivers and the set of bids, to the user. Moreover, the method comprises receiving from the user by the processor via the output module, a selection for at least one taxi driver from the set of taxi, charter & delivery drivers.

Further provided within the system is a means to enable customers to request competitive bids from various taxi and transportation services providers and other pay-for-service means from a designated pick-up or drop location. The customer first receives a list of transportation providers (i.e., taxi, charter & delivery driver) based on the corresponding designated parameter provided from the customer and display a competitive bid collaborative space on a hand-held mobile device or personal computers. The system further enables the transportation providers to interact with consumers in a secure and personalized means by incorporating elements within the mobile application including incentives, which provide benefits for both customers and taxi, charter & delivery drivers. The system further provides a platform to request and receive bids from taxi, charter & delivery drivers and sort bids according to desired criteria which allow customers to efficiently acquire a transportation means for a desired route from a service provider based on recommended bid prices and further include an incentive advertising system based on the desired destination.

Further embodiments provide method in which consumers and service providers may further continue their collaboration for future transactions using personalized messages and incentives based on the reviews of the both the service provider and customer. The system further contemplates desired parameters include at least vehicle type/class.

Other aspects, advantages, and novel features of the embodiments will become apparent from the following detailed description in conjunction with the drawings.

### BRIEF DESCRIPTION OF THE DRAWINGS

A more complete understanding of the embodiments, and the attendant advantages and features thereof, will be more readily understood by reference to the following detailed description when considered in conjunction with the accompanying drawings wherein:

FIG. 1 is a block diagram of an environment implemented in accordance with one embodiment of the present invention.

FIG. 2 is a flowchart of a method of implementing an electronic competitive bidding system for taxi, charter & delivery services in accordance with one embodiment of the present invention.

### DETAILED DESCRIPTION

The specific details of the single embodiment or variety of embodiments described herein are set forth in this application. Any specific details of the embodiments are used for demonstration purposes only and no unnecessary limitation or inferences are to be understood therefrom. Furthermore, as used herein, relational terms, such as “first” and “second,” “top” and “bottom,” and the like, may be used solely to distinguish one entity or element from another entity or element without necessarily requiring or implying any physical or logical relationship, or order between such entities or elements.

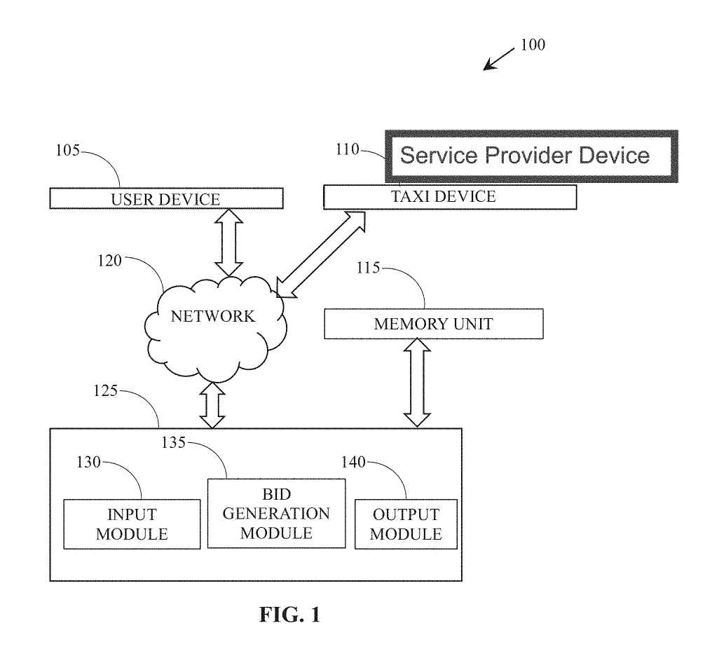

FIG. 1 is a block diagram of an environment 100 in accordance with one embodiment of the present invention. The environment 100 comprises a user device 105, a taxi device 110, and a processor 125. In one example, the user device 105 is at least one of a laptop, a mobile phone, and a personal computer. In another example, the taxi device 110 is at least one of a laptop, a mobile phone, and a personal computer. The user device 105, the taxi device 110 and the processor 125 communicate via a network 120. The network 120 is at least one of a Bluetooth network, a WIFI network, a mobile network, and a local area network. The processor 125 is at least one of a microprocessor 125, a microcontroller, a smart phone, a personal computer, a server, and a laptop. The environment 100 comprises a system for implementing an electronic competitive bidding system for taxi services. The memory unit 115 is configured to store information regarding a plurality of taxi drivers, and a set of program modules. Information regarding the plurality of taxi drivers comprises locations of each of the plurality of taxi drivers and vehicle type and vehicle class of each of the plurality of taxi, charter & delivery drivers. The memory unit 115 further stores personal profile of the user comprising name of the user, location of the user, and travel history of the user. The processor 125 executes the set of programs modules. The set of program modules comprises an input module 130, a bid generation module 135, and an output module 140. The input module 130 receives user preferences from a user.

The user preferences comprise location of the user, travel & delivery schedule of the user, car type preferred by the user, transportation type, transportation route, a selected vehicle type and a selected vehicle class and intended destination of the user. In another embodiment of the present invention, the input module 130 receives the user preferences from the user via the user device 105. The bid generation module 135 transmits the user preferences to the plurality of taxi, charter & delivery drivers, and receive a set of bids from a set of taxi, charter &delivery drivers among the plurality of taxi, charter & delivery drivers. Further, the bid generation module 135 transmits the user preferences to the plurality of taxi, charter & delivery drivers via the taxi, charter & delivery device 110. The bid generation module 135 is further configured to calculate a competitive bid in response to reception of the user preferences from the user. The bid generation module 135 alerts the at least one taxi, charter & delivery driver based on the at least one taxi, charter & delivery driver being selected by the user. The output module 140 displays information regarding the set of taxi drivers and the set of bids, to the user, and receives from the user a selection for at least one taxi, charter & delivery driver from the set of taxi, charter & delivery drivers. The output module assigns the at least one taxi, charter & delivery driver to the user.

In one example, the user transmits the user preferences via a customer request process. The customer request process comprises a typical data set for display on the user interface or mobile application. Further, the system comprises a bidding mechanism and associated logic commands. If the user is a first-time user, then the system will request the user of a goal and a desired route of a transportation system. In another example, the user preferences comprise “pick-up location”, “drop-off location” and destination parameters. In another example, the user preferences comprise optional desired parameters such as vehicle type and vehicle class. The system is further configured include a feature of adding additional passengers, number of bags, content of the bags, food and any products to ensure safe delivery. Further, the system allows the user to select a specific driver and vehicle type and enable the user to input any positive or negative feedback about the taxi, charter & delivery driver. Further, the system enables the user to fill a fillable form and alerts the user with a text message comprising sentence “incoming bid message”, which alerts the user that the taxi driver has viewed request for taxi, charter & delivery services and has provided a completive bid in response. Conversely, the user may receive an alert such as “no vehicle found” if a responsive competitive bid is not inputted by the taxi, charter & delivery driver.

The location and destination information genially comprise a city, state, and street address and may optionally include location specific information such as “waiting outside grocery store” or “please call when arrive.” The system reconciles input with driver history and stored records within the memory unit 115 and incorporates former user information and user requests. The system further incorporates local mapping and interface with popular user marketplace sites and mobile apps.

Any customer may choose to become a registered member by auto filling the parameters contained on the mobile app or the user may anonymously request services without providing personal information.

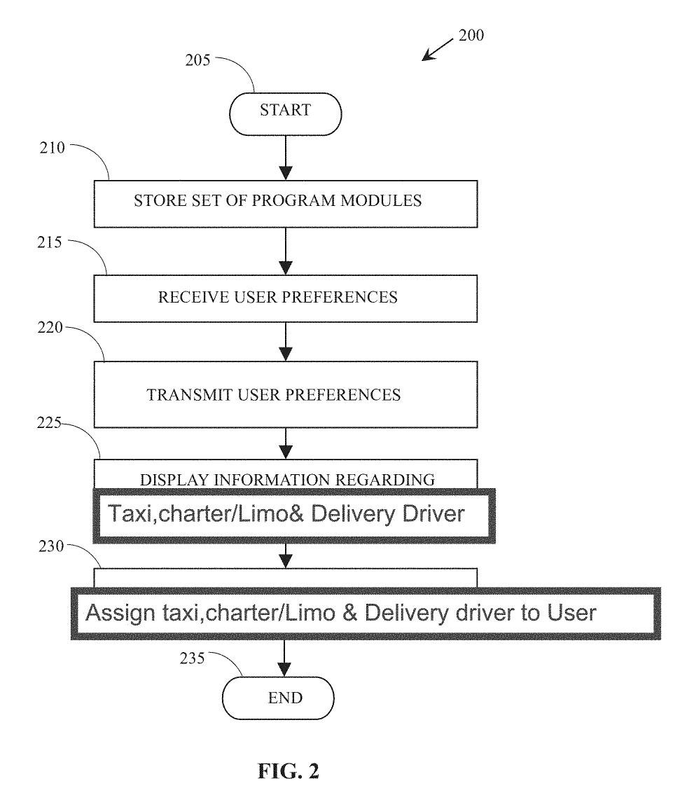

FIG. 2 is a flowchart of a method 200 of implementing an electronic competitive bidding system for services in accordance with one embodiment of the present invention. The method 200 of implementing an electronic competitive bidding system for taxi, charter & delivery services are implemented in an environment comprising a user device, a taxi device, and a processor. The method 200 commences at step 205.

At step 210, a memory unit stores information regarding a plurality of taxi, charter & delivery drivers, and a set of program modules. Information regarding the plurality of taxi, charter & delivery drivers comprise locations of each of the plurality of taxi, charter & delivery drivers and vehicle type and vehicle class of each of the plurality of taxi, charter & delivery drivers.

At step 215 the processor, via an input module, receives user preferences from a user. The user preferences comprise location of the user, travel schedule of the user, car type preferred by the user, transportation type, transportation route, a selected vehicle type and a selected vehicle class and intended destination of the user.

At step 220, the processor via a bid generation module transmits the user preferences to the plurality of taxi, charter & delivery drivers. Furthermore, the method comprises receiving by the processor via the bid generation module a set of bids from a set of taxi, charter & delivery drivers among the plurality of taxi, charter & delivery drivers.

At step 225 the processor via an output module, displays information regarding the set of taxi drivers and the set of bids, to the user. Moreover, the processor via the output module receives a selection for at least one taxi driver from the set of taxi drivers.

At step 230, the processor assigns the taxi, charter & delivery driver to the user.

The method 200 ends at step 235.

In one example, the method 200 further comprises an alert notification and driver acceptance procedure. In accordance with the alert notification and driver acceptance procedure, the taxi, charter & delivery driver is required to enter a competitive bid which enables instant booking for the user. Further, the alert notification and driver acceptance procedure comprises transmittal of a summary data sent to the user based on location of the user and includes service request parameters from the user. The alert notification and driver acceptance procedure transmits alerts from the user to the taxi, charter & delivery driver determine if the taxi, charter & delivery driver can complete a desired route and if the desired route is monetarily advantageous to take the competitive bid. The user receives recommendation from the processor. The processor provides recommendation to ensure that bids from the plurality of taxi, charter & delivery drivers are “competitive”. Further, the processor enables “instant booking”. Also, the alert notification and the driver acceptance procedure prevents “double bookings”.

In another example, if an administrator downloads a central mobile application comprising the method of implementing the competitive bidding system for the taxi, charter & delivery services, then the administrator is enabled to establish one or more marketplaces for competitive bidding system. In another example, the method 200 comprises generation of receipts and bills after the destination has reached.

It will be appreciated by persons skilled in the art that the present embodiment is not limited to what has been particularly shown and described hereinabove. In addition, unless mention was made above to the contrary, it should be noted that all the accompanying drawings are not to scale. A variety of modifications and variations are possible considering the above teachings without departing from the following claims.

What is claimed is:

1. A system for implementing an electronic competitive bidding system for taxi services, the system comprising:
a memory unit configured to store: information regarding a plurality of taxi, charter & delivery drivers, and a set of program modules, wherein information regarding the plurality of taxi, charter & delivery drivers comprises locations of each of the plurality of taxi, charter & delivery drivers and vehicle type and vehicle class of each of the plurality of taxi, charter & delivery drivers;
a processor to execute the set of program modules, the set of program modules comprising:
an input module, executed by the processor, configured to receive user preferences from a user, wherein the user preferences comprise location of the user, travel schedule of the user, car type preferred by the user, transportation type, transportation route, a selected vehicle type and a selected vehicle class and intended destination of the user;
a bid generation module, executed by the processor, configured to: transmit the user preferences to the plurality of taxi, charter & delivery drivers, and receive a set of bids from a set of taxi, charter & delivery drivers among the plurality of taxi drivers;
an output module, executed by the processor, configured to:
display information regarding the set of taxi drivers and the set of bids, to the user, receive from the user a selection for at least one taxi, charter & delivery driver from the set of taxi, charter & delivery drivers, and assign the at least one taxi, charter & delivery driver to the user.

2. The system of claim 1, wherein the input module receives the user preferences from the user via at least one of a personal computer, a tablet computer, and a mobile device.

3. The system of claim 1, wherein the bid generation module transmits the user preferences to the plurality of taxi, charter & delivery drivers via at least one of a personal computer, a tablet computer, and a mobile device.

4. The system of claim 1, wherein the memory unit further stores personal profile of the user comprising name of the user, location of the user, and travel & delivery history of the user.

5. The system of claim 1, wherein the bid generation module is further configured to calculating a competitive bid in response to reception of the user preferences from the user.

6. The system of claim 1, wherein the bid generation module alerts the at least one taxi driver based on the at least one taxi, charter & delivery driver being selected by the user.

7. A method of implementing an electronic competitive bidding system for taxi, charter & delivery services, the method comprising:
storing in a memory unit, information regarding a plurality of taxi, charter & delivery drivers, and a set of program modules, wherein information regarding the plurality of taxi, charter & delivery drivers comprises locations of each of the plurality of taxi, charter & delivery drivers and vehicle type and vehicle class of each of the plurality of taxi, charter & delivery drivers; receiving by a processor, via an input module, user preferences from a user, wherein the user preferences comprise location of the user, travel & delivery schedule of the user, car type preferred by the user, transportation type, transportation route, a selected vehicle type and a selected vehicle class and intended destination of the user; transmitting by the processor via a bid generation module, the user preferences to the plurality of taxi, charter & delivery drivers; receiving by the processor via the bid generation module a set of bids from a set of taxi, charter & delivery drivers among the plurality of taxi, charter & delivery drivers; displaying by the processor via an output module, information regarding the set of taxi, charter & delivery drivers and the set of bids, to the user; receiving from the user by the processor via the output module, a selection for at least one taxi driver from the set of taxi, charter & delivery drivers; and assigning by the processor via the output module, the at least one taxi, charter & delivery driver to the user.

8. The method of claim 7, wherein the input module receives the user preferences from the user via at least one of a personal computer, a tablet computer, and a mobile device.

9. The method of claim 7, wherein the bid generation module transmits the user preferences to the plurality of taxi, charter & delivery drivers via at least one of a personal computer, a tablet computer, and a mobile device or mobile application.

10. The method of claim 7, wherein the memory unit further stores personal profile of the user comprising name of the user, location of the user, and travel & delivery history of the user.

11. The method of claim 7, wherein the bid generation module is further configured to calculating a competitive bid in response to reception of the user preferences from the user.

12. The method of claim 7, wherein the bid generation module alerts the at least one taxi, charter & delivery driver based on the at least one taxi, charter & delivery driver being selected by the user.
